(19) United States
(12) Patent Application Publication
(10) Pub. No.: US 2023/0274207 A1
(43) Pub. Date: Aug. 31, 2023

(54) WORK PLAN PREDICTION

(71) Applicant: BMC Software Israel Ltd, Tel-Aviv (IL)

(72) Inventor: Amos Uzan, Yavne (IL)

(21) Appl. No.: 17/652,831

(22) Filed: Feb. 28, 2022

(51) Int. Cl. G06Q 10/06

(52) U.S. Cl. CPC G06Q 10/063118; G06Q 10/063114

(57) ABSTRACT

In some aspects, the system and techniques include collecting from a database completed tasks data for ended sprints of a team and planned tasks data for future sprints by the team. The completed tasks data for ended sprints includes actual resource capacity and completed plan data, and the planned tasks data for future sprints includes expected resource capacity and future plan data. A velocity for the team is calculated using the completed tasks data for ended sprints. A story point prediction for the future sprints by the team is calculated using the velocity and the expected resource capacity from the planned tasks data for future sprints. A visualization of the story point prediction for the future sprints by the team is generated and output to a display.

### TECHNICAL FIELD

This description relates to work plan prediction.

### BACKGROUND

Software project management involves the planning, scheduling, resource allocation, execution, tracking, and delivery of software. One style of software project management uses the Agile methodology that is characterized by developing software using cycles of work that allow for production and revision. The Agile method works in ongoing “sprints” of project planning and execution that enables managers and developers to continuously adapt and mature the plan, scope, and design throughout the project. The Agile method uses an iterative approach. The Agile method includes several different frameworks including, for example, Scrum, Kanban, Extreme Programming (XP), and Adaptive Project Framework (APF).

For instance, Scrum is a popular Agile development framework that allows for rapid development and testing. Scrum is often used to manage complex software and product development using iterative and incremental practices. A Scrum master leads a small team of developers (e.g., five to nine people) and the team works in short cycles (e.g., two weeks, three weeks, four weeks, etc.) called “sprints” on units of work referred to as “user stories,” which are also referred to interchangeably as “stories.”

The story is an informal, general explanation of a software feature that may be written from the perspective of the end user or customer. In general, the story is a technical explanation for small software unit development. Story points are commonly used as a unit of measure for specifying the overall size of a story or task. When a team estimates with story points, it assigns a point value (i.e., story points) to each story. A story point estimate reflects the relative amount of effort involved in implementing the story. Story points are assigned relative to the work complexity, the amount of work, and risk or uncertainty. For example, a story that is assigned two story points should take twice as much effort as a story assigned one story point. Story points may have a value between 1 and 20.

Story points are used to compute velocity, which is a measure of a team’s progress rate per iteration. One measure of velocity is calculated by summing all the story points assigned to each story completed by the team in the current iteration. For example, if the team members resolve four stories each estimated at four story points, their velocity is sixteen per iteration. Velocity is used for planning and predicting when a software (or release) should be completed. For example, if the team estimates the next release to include 100 story points and the team’s current velocity is 20 points per 2-week iteration, then it would take 5 iterations (or 10 weeks) to complete the project.

Capacity planning is used to help a team understand how many story points are likely to be accomplished within a sprint. Team capacity or resource capacity refers to the number of development hours available for a sprint and may be measured in workdays. Another measure of velocity for the team is calculated by taking the sum of the story points for the team and dividing it by team member capacity in workdays to arrive at value that is the ratio of the story points to the capacity.

Current software project management tools may not factor in changes to resource capacity from sprint to sprint and the effect that the changes have on planning using story points. For example, resource capacity may vary from sprint to sprint due to vacation, holidays, personal days off, etc. Improvements to software project management tools are desirable.

### SUMMARY

In some aspects, the techniques described herein relate to a computer-implemented method including: collecting, by a computing device, from a database completed tasks data for ended sprints of a team and planned tasks data for future sprints by the team, where: the completed tasks data for ended sprints includes actual resource capacity and completed plan data, and the planned tasks data for future sprints includes expected resource capacity and future plan data; calculating, by the computing device, a velocity for the team using the completed tasks data for ended sprints; calculating, by the computing device, a story point prediction for the future sprints by the team using the velocity and the expected resource capacity from the planned tasks data for future sprints; and generating and outputting to a display, by the computing device, a visualization of the story point prediction for the future sprints by the team.

In some aspects, the techniques described herein relate to a computer-implemented method, further including: receiving an input via a graphical user interface (GUI) for a number of ended sprints to include in the velocity, and where calculating the velocity includes calculating, by the computing device, the velocity for the team using the input received via the GUI for the number of ended sprints.

In some aspects, the techniques described herein relate to a computer-implemented method, further including: receiving a new input via the GUI for a different number of ended sprints to include in the velocity; updating, by the computing device, the velocity for the team using the new input received via the GUI for the different number of ended sprints; calculating, by the computing device, an updated story point prediction for the future sprints by the team using the updated velocity and the expected resource capacity from the planned tasks data for future sprints; and generating and outputting to the display, by the computing device, an updated visualization of the updated story point prediction for the future sprints by the team.

In some aspects, the techniques described herein relate to a computer-implemented method, where calculating the velocity includes: summing story points from the completed plan data; summing workdays for the team from the actual resource capacity; and dividing the summed story points by the summed workdays to arrive at the velocity for the team.

In some aspects, the techniques described herein relate to a computer-implemented method, where calculating the story point prediction includes multiplying the expected resource capacity by the velocity.

In some aspects, the techniques described herein relate to a computer-implemented method, where generating and outputting the visualization includes generating and outputting to the display, by the computing device, the visualization of the story point prediction and the future plan data for the future sprints by the team.

In some aspects, the techniques described herein relate to a computer-implemented method, where: the actual resource capacity and the expected resource capacity is measured in workdays; and the completed plan data and the future planned data is measured in story points.

In some aspects, the techniques described herein relate to a computer program product, the computer program product being tangibly embodied on a non-transitory computer-readable medium and including executable code that, when executed, causes a computing device to: collect completed tasks data for ended sprints by a team and planned tasks data for future sprints by the team from a database, where: the completed tasks data for ended sprints includes actual resource capacity and completed plan data, and the planned tasks data for future sprints includes expected resource capacity and future plan data; calculate a velocity for the team using the completed tasks data for ended sprints; calculate a story point prediction for the future sprints by the team using the velocity and the expected resource capacity from the planned tasks data for future sprints; and generate and output to a display a visualization of the story point prediction for the future sprints by the team.

In some aspects, the techniques described herein relate to a computer program product, further including executable code that, when executed, causes the computing device to: receive an input via a graphical user interface (GUI) for a number of ended sprints to include in the velocity, and where the executable code that, when executed, causes the computing device to calculate the velocity for the team using the input received via the GUI for the number of ended sprints.

In some aspects, the techniques described herein relate to a computer program product, further including executable code that, when executed, causes the computing device to: receive a new input via the GUI for a different number of ended sprints to include in the velocity; update the velocity for the team using the new input received via the GUI for the different number of ended sprints; calculate an updated story point prediction for the future sprints by the team using the updated velocity and the expected resource capacity from the planned tasks data for future sprints; and generate and output to the display an updated visualization of the updated story point prediction for the future sprints by the team.

In some aspects, the techniques described herein relate to a computer program product, where the executable code that, when executed, causes the computing device to calculate the velocity includes executable code that, when executed, causes the computing device to: sum story points from the completed plan data; sum workdays for the team from the actual resource capacity; and divide the summed story points by the summed workdays to arrive at the velocity for the team.

In some aspects, the techniques described herein relate to a computer program product, where the executable code that, when executed, causes the computing device to calculate the story point prediction by multiplying the expected resource capacity by the velocity.

In some aspects, the techniques described herein relate to a computer program product, where the executable code that, when executed, causes the computing device to generate and output to the display the visualization of the story point prediction and the future plan data for the future sprints by the team.

In some aspects, the techniques described herein relate to a computer program product, where: the actual resource capacity and the expected resource capacity is measured in workdays; and the completed plan data and the future planned data is measured in story points.

In some aspects, the techniques described herein relate to a system including: at least one processor; and a non-transitory computer-readable medium including instructions that, when executed by the at least one processor, cause the system to: collect from a database completed tasks data for ended sprints by a team and planned tasks data for future sprints by the team, where: the completed tasks data for ended sprints includes actual resource capacity and completed plan data, and the planned tasks data for future sprints includes expected resource capacity and future plan data; calculate a velocity for the team using the completed tasks data for ended sprints; calculate a story point prediction for the future sprints by the team using the velocity and the expected resource capacity from the planned tasks data for future sprints; and generate and output to a display a visualization of the story point prediction for the future sprints by the team.

In some aspects, the techniques described herein relate to a system, further including instructions that, when executed by the at least one processor, cause the system to: receive an input via a graphical user interface (GUI) for a number of ended sprints to include in the velocity, and where the instructions that, when executed by the at least one processor, cause the system to calculate the velocity for the team using the input received via the GUI for the number of ended sprints.

In some aspects, the techniques described herein relate to a system, further including instructions that, when executed by the at least one processor, cause the system to: receive a new input via the GUI for a different number of ended sprints to include in the velocity; update the velocity for the team using the new input received via the GUI for the different number of ended sprints; calculate an updated story point prediction for the future sprints by the team using the updated velocity and the expected resource capacity from the planned tasks data for future sprints; and generate and output to the display an updated visualization of the updated story point prediction for the future sprints by the team.

In some aspects, the techniques described herein relate to a system, where the instructions that, when executed by the at least one processor calculate the velocity by causing the system to: sum story points from the completed plan data; sum workdays for the team from the actual resource capacity; and divide the summed story points by the summed workdays to arrive at the velocity for the team.

In some aspects, the techniques described herein relate to a system, where the instructions that, when executed by the at least one processor calculate the story point prediction by causing the system to multiply the expected resource capacity by the velocity.

In some aspects, the techniques described herein relate to a system, where the instructions that, when executed by the at least one processor generate and output to the display the visualization of the story point prediction and the future plan data for the future sprints by the team.

In some aspects, the techniques described herein relate to a system, where: the actual resource capacity and the expected resource capacity is measured in workdays; and the completed plan data and the future planned data is measured in story points.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for software project management.

FIG. 2 is an example flowchart for a process illustrating example operations of the system of FIG. 1.

FIG. 3 is an example screenshot of a dashboard for displaying a visualization of the story point prediction for future sprints.

FIG. 4 is an example screenshot of the area of the dashboard from FIG. 3.

FIG. 5 is an example screenshot of the area of the dashboard with the slide bar selected to include six ended sprints in the velocity.

FIG. 6 is an example screen shot illustrating a data entry screen for inputting the team member resource capacity.

### DETAILED DESCRIPTION

This document describes systems and techniques for predicting story points for a team (also referred to interchangeably as a Scrum team) for future sprints. The systems and techniques described herein provide technical solutions to the technical problems encountered as part of the software management development process. The systems and techniques described herein provide accurate and reliable predictions for the number of story points a team is capable of accomplishing or is likely to accomplish during future software development iterations by using a combination of parameters that account for both resource capacity and plan data.

More specifically, a combination of completed plan data, as measured in story points, and actual resource capacity, as measured in workdays, from completed tasks are collected and used to determine a velocity for a team, which is then used for predicting story points for the team for future tasks. By factoring in the actual resource capacity from past tasks, the prediction accounts for varying workdays from iteration to iteration due to vacation, holidays, personal days off, etc. Factoring in the actual resource capacity in combination with the number of actual story points completed during the iterations results in a more accurate and more reliable prediction of story points a team is capable of completing during future iterations. This results in a direct improvement to more efficient and timely software development cycles with less deviation from future planned data as compared to common and conventional techniques used in current software project management.

Additionally, the number of completed tasks to use in determining the team’s velocity may be configurable and/or user-selectable to enable further refinement and granularity in selecting the combination of data to be used for predicting story points for future sprints. In some implementations, a graphical user interface (GUI) may be used to enable the user-selection of the number of completed tasks.

A visualization of the predicted story points for future iterations is generated and output to a display. The visualization may graphically illustrate a comparison between future plan data and predicted plan data. Additionally, the visualization may graphically illustrate completed tasks data for ended sprints. In this manner, a graphical comparison is provided for user evaluation of both historical data, future plan data, and predicted plan data. The systems and techniques described herein provide an updated visualization in real-time (or near real-time) in response to updates and/or adjustments made to future plan data, the number of completed tasks included in the prediction, and/or the expected resource capacity.

### Definitions

As used herein, a team or a Scum team refers to a group of members (or developers or engineers or other persons) assigned to work on a task for a project such as, for example, a software and/or hardware project.

As used herein, a Scrum master refers to the leader of the team or Scrum team. Typically, the Scrum master is responsible for developing and managing planned tasks including expected resource capacity and future plan data.

As used herein, a sprint refers to a cycle of work or an iteration for a team that is measured in a period of time such as, for example, one week, two weeks, three weeks, four weeks, etc.

As used herein, an ended sprint refers to a sprint that has been completed. It is a sprint that occurred in the past.

As used herein, a future sprint refers to a sprint that has not started and is to occur at a future point in time. A future sprint is one that has not been completed.

As used herein, a story refers to an informal, general explanation of a software feature that may be written from the perspective of the end user or customer. In general, a story refers to a technical explanation for small software unit development.

As used herein a task refers to work to be done, assigned, or undertaken by a team or Scrum team. The task may be assigned by the Scrum master. A task may be a portion of work for a small software unit development or task may be the complete work for a small software unit development.

As used herein, the term story point(s) refers a unit of measure for specifying the overall size of a story or task. When a team estimates with story points, it assigns a point value (i.e., story points) to each story or task. A story point estimate reflects the relative amount of effort involved in implementing the story or task. Story points are assigned relative to the work complexity, the amount of work, and risk or uncertainty.

As used herein, completed tasks data for ended sprints refers to actual resource capacity and completed plan data for tasks where the time frame for the tasks has ended. Completed tasks data includes historical data for the actual resource capacity and the completed plan data used to complete the tasks.

As used herein, actual resource capacity refers to the number of development hours used for a completed sprint and may be measured in workdays. The actual resource capacity is part of the historical completed tasks data.

As used herein, completed plan data refers to the number of story points completed or delivered during a sprint. The completed plan data is part of the historical completed tasks data.

As used herein, velocity (or velocity for the team) refers to a ratio of story points to resource capacity. The ratio for velocity is in story points per workday. The velocity for the team may be calculated by taking the sum of the story points from the completed plan data and dividing it by the sum of the workdays for the team from the actual resource capacity.

As used herein, planned tasks data for future sprints refers to expected resource capacity and future plan data for upcoming sprints.

As used herein, expected resource capacity refers to the number of development hours planned for in a future sprint and may be measured in workdays. The expected resource capacity is part of the planned tasks data.

As used herein, future plan data refers to the number of story points planned in a future sprint. The future plan data is part of the planned tasks data.

As used herein, a story point prediction for future sprints refers to a measure of the velocity multiplied by the expected resource capacity. The story point prediction is measured in story points.

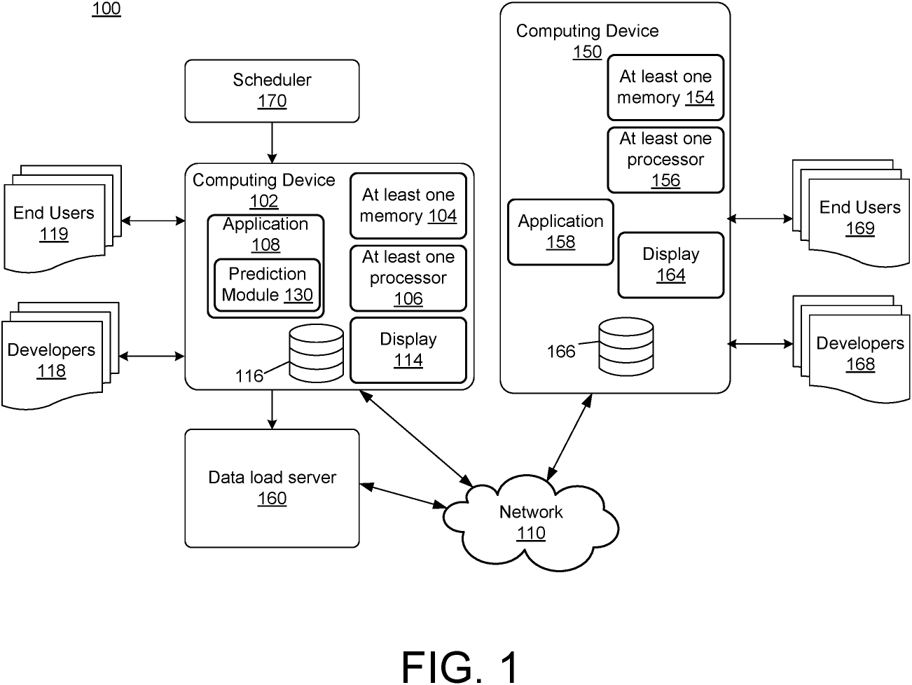

FIG. 1 is a block diagram of a system 100 for software project management. While the example context of system 100 is software project management, the techniques and concepts described herein and explained in the software project management context may be applied to other project management contexts such as, for example, hardware project management or any other type of work management effort.

The system 100 includes a computing device 102, a computing device 150, a data load server 160, a scheduler 170, and a network 110. The computing device 102 includes at least one memory 104, at least one processor 106, an application 108, a display 114, and a database 116. The computing device 102 may communicate with one or more other computing devices over the network 110. For instance, the computing device 102 may communicate with the computing device 150 and the data load server 160 over the network 110. The computing device 102 may communicate with many other computing devices and other devices and components over the network 110. The computing device 102 may be implemented as a server (e.g., an application server), a desktop computer, a laptop computer, a mobile device such as a tablet device or mobile phone device, a mainframe, a virtual machine, as well as other types of computing devices. In one example implementation, the computing device 102 may be a Qlik Sense® production server, the database 116 may be a Qlik Sense® database, the data load server 160 may be a Qlik Sense® data load server, and the scheduler 170 may be a Jenkins job scheduler server.

The computing device 102 may be accessed and used by different persons having different roles. For example, the computing device 102 may be accessed and used by both developers 118 and end users 119.

Although a single computing device 102 is illustrated, the computing device 102 may be representative of multiple computing devices in communication with one another, such as multiple servers in communication with one another being utilized to perform various functions over a network. In some implementations, the computing device 102 may be representative of multiple virtual machines in communication with one another in a virtual server environment, including those in a cloud environment or on a mainframe. In some implementations, the computing device 102 may be representative of one or more mainframe computing devices.

The at least one processor 106 may represent two or more processors on the computing device 102 executing in parallel and utilizing corresponding instructions stored using the at least one memory 104. The at least one processor 106 may include at least one graphics processing unit (GPU) and/or central processing unit (CPU). The at least one memory 104 represents a non-transitory computer-readable storage medium. Of course, similarly, the at least one memory 104 may represent one or more different types of memory utilized by the computing device 102. In addition to storing instructions, which allow the at least one processor 106 to implement the application 108 and its various components, the at least one memory 104 may be used to store data, such as rules, views, user interfaces (UI), and information used by and/or generated by the application 108 and the components used by application 108.

The computing device 150 includes at least one memory 154, at least one processor 156, an application 158, a display 164, and a database 166. The computing device 150 may communicate with one or more other computing devices over the network 110. For instance, the computing device 150 may communicate with the computing device 102 and the data load server 160 over the network 110. The computing device 150 may communicate with many other computing devices and other devices and components over the network 110. The computing device 150 may be implemented as a server (e.g., an application server), a desktop computer, a laptop computer, a mobile device such as a tablet device or mobile phone device, a mainframe, a virtual machine, as well as other types of computing devices. In one example implementation, the computing device 150 may be a Jira production server and the database 166 may be a Jira database. The computing device 150 may be accessed and used by different persons having different roles. For example, the computing device 150 may be accessed and used by both developers 168 and end users 169.

The at least one memory 154 and the at least one processor 156 may be similar to and include the same features and functions as the least one memory 104 and the at least one processor 156, as described above.

The network 110 may be implemented as the Internet but may assume other different configurations. For example, the network 110 may include a wide area network (WAN), a local area network (LAN), a wireless network, an intranet, combinations of these networks, and other networks. Of course, although the network 110 is illustrated as a single network, the network 110 may be implemented as including multiple different networks.

In some implementations, the application 108 is a data analytics application and the application 158 is a project management application. In some implementations, the application 108 functions as both a data analytics application and a project management application. Similarly, in some implementations, the application 158 may function as both a data analytics application and a project management application. While various features and functions may be described herein as being split and performed by the application 108 on the computing device 102 and the application 158 on the computing device 150, it is understood that the features and functionalities may be performed in full by either the application 108 or the application 158. Also, it is understood that the features and functionalities may be shared and performed by both the application 108 and the application 158 in a manner different from the manner described herein.

The computing device 102 and the application 108 may be configured and programmed to predict story points for a team for future sprints. The application 108 may include a prediction module 130 that may be programmed to predict story points for a team for future sprints. The prediction module 130 may be configured to collect completed tasks data for ended sprints by a team and planned tasks data for future sprints by the team from a database. For example, in some implementations the completed tasks data for ended sprints and the planned tasks data for future sprints may be stored in the database 166. The application 158 in its function as a project management application may be configured to track the completed tasks data for sprints for a team and to store the completed tasks data in the database 166. For each sprint that is completed by a team, the data and information for the ended sprint may be stored in the database 166. The prediction module 130 may collect the data and information for ended sprints from the database 166. In some implementations, the prediction module 130 may use the data load server 160 to assist in collecting and pulling the data and information for completed tasks for ended sprints from the database 166 via the network 110.

The completed tasks data for ended sprints includes historical data for actual resource capacity and completed plan data. The actual resource capacity refers to the number of development hours used for a completed sprint and may be measured in workdays. The actual resource capacity is part of the historical completed tasks data. The completed plan data refers to the number of story points completed or delivered during a sprint. The completed plan data is part of the historical completed tasks data.

In a similar manner, the application 158 in its function as a project management application may be used and configured to capture planned tasks data for future sprints and to store the planned tasks data in the database 166. For each sprint that is planned for the team, the data and information for the future sprint may be stored in the database 166. The prediction module 130 may collect the data and information for future sprints from the database 166. In some implementations, the prediction module 130 may use the data load server 160 to assist in collecting and pulling the data and information for planned tasks for future sprints from the database 166 via the network 110.

The planned tasks data for future sprints includes the expected resource capacity and future plan data for upcoming sprints. The expected resource capacity refers to the number of development hours planned for in a future sprint and may be measured in workdays. The expected resource capacity is part of the planned tasks data. The future plan data refers to the number of story points planned in a future sprint. The future plan data is part of the planned tasks data.

The prediction module 130 uses the historical information collected as part of the completed tasks data to calculate a velocity for the team. The prediction module 130 may calculate a velocity for each sprint completed by the team. The prediction module 130 totals or sums the story points completed by the team during the sprint. The completed plan data includes the story points completed by the team during the sprint. The prediction module 130 totals or sums the workdays for the team during the sprint. The actual resource capacity includes the number of workdays performed by the team during the sprint. The prediction module 130 calculates the velocity by dividing the summed story points by the summed workdays to arrive at the velocity for the team. The velocity (or velocity for the team) refers to a ratio of story points to resource capacity. The ratio for the velocity is in the unit of story points per workday.

While the prediction module 130 may calculate the velocity for the team for a single sprint, the prediction module 130 also may calculate the velocity for the team for a number of sprints completed by the team. The number of sprints to include in the velocity calculation may be a default number (e.g., 3 sprints, 4 sprints, 5 sprints, etc.). Additionally and/or alternatively, the number of sprints to include in the velocity calculation may be user-selectable and/or user-configurable. For instance, the application 108 be configured to generate and provide a graphical user interface (GUI) that may be configured to receive an input for a number of ended sprints to include in the velocity. The prediction module 130 may receive the input from the GUI and calculate a velocity using the input for the number of ended sprints. The prediction module 130 sums the story points from the completed plan data for the number of ended sprints and sums the workdays for the team from the actual resource capacity for the number of ended sprints. The prediction module 130 calculates the velocity for the number of ended sprints by dividing the summed story points by the summed workdays. In this manner, the prediction module 130 may use historical completed tasks data as collected from a database 116 or database 166 to calculate a velocity for a team over a number of sprints, where the number of sprints may be a default number and/or a user-selectable number.

The prediction module 130 uses the velocity for the team to calculate a story point prediction for the future sprints by the team. The prediction module 130 calculates the story point prediction using the velocity and the expected resource capacity from the planned tasks data for future sprints. The prediction module 130 multiplies the velocity, which is in story points per workday, by the expected resource capacity, which is in workdays, to arrive at the story point prediction, which is in story points. For example, if the velocity is 1.3 story points per workday and the expected resource capacity is 45 workdays, then the story point prediction is 58.5 story points (1.3 story points/workday x 45 workdays = 58.5 story points). The story point prediction of 58.5 story points means that a Scrum master can plan 58.5 story points for the future sprint for the team having 45 workdays of expected resources for that future sprint.

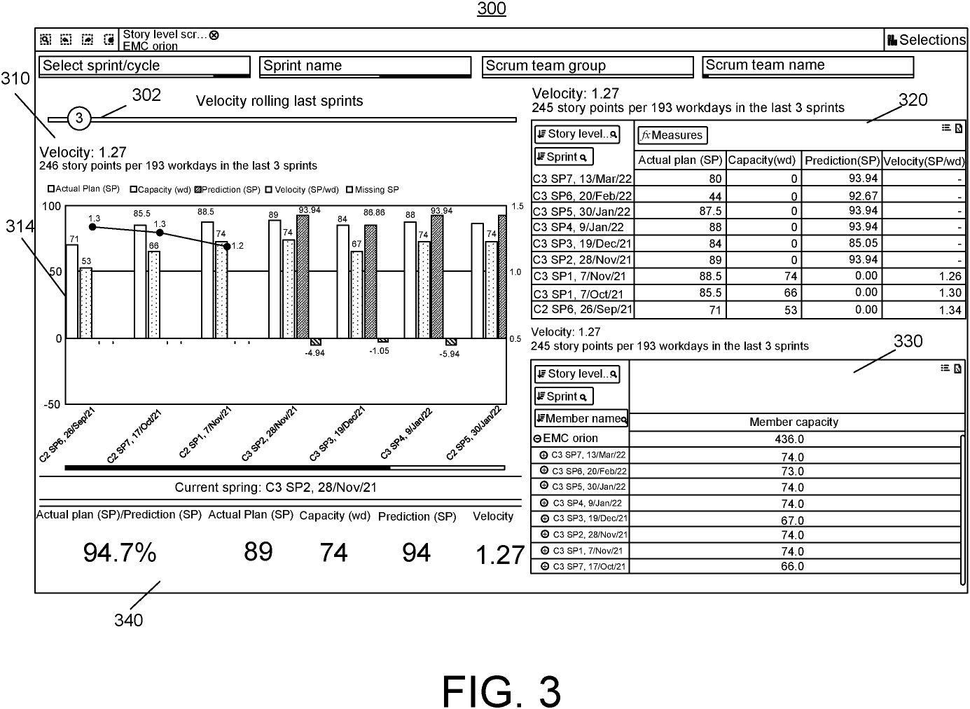

The prediction module 130 may generate and output a visualization of the story point prediction for the future sprints by the team to the display 114. As discussed below in more detail with respect to FIGS. 3-5, the prediction module 130 generates and outputs the visualization of the story point prediction to provide a graphical representation of the story point prediction for viewing by a user. The visualization may illustrate the story point prediction for multiple future sprints, where the story point prediction may vary for each sprint based on the expected resource capacity for each of the future sprints. For instance, in the example calculation above the expected resource capacity for the future sprint is 45 workdays. For the next sprint following that sprint, the expected resource capacity for the next sprint may be 51 workdays. The prediction module 130 would calculate a story point prediction for the next sprint by multiplying the velocity for the team (1.3 story points/workday) by the 51 workdays to arrive at a story point prediction of 66.3 story points for the next sprint. The prediction module 130 may generate a visualization for both sprints for output to the display 114 for a user to see the story point predictions for the two future sprints in the same visualization. In some implementations, the prediction module may generate a visualization for many future sprints for the user to see the story point predictions for many (i.e., unlimited) future sprints in the same visualization.

In this manner, a Scrum master may use the story point predictions to compare against the future plan data. The prediction module 130 may output the future plan data as measured in story points as part of the visualization against the story point predictions. The Scrum master can use the illustrated comparison of the story point predictions and the future plan data as a planning tool for the future sprints and may make changes to the future plan data based on the story point predictions. For instance, if the story point prediction indicates that the team is predicted to completed 58.5 story points in the next sprint and the Scrum master has planned for the team to complete only 50 story points, then the Scrum master can use the predicted information to update the future plan data by planning to complete more story points during the sprint.

The prediction module 130 may update the calculated story point predictions in real-time or near-real time as new input is received from the GUI for the number of ended sprints to include in the velocity. For example, in response to receiving a new input via the GUI for a different number of ended sprints to include in the velocity, the prediction module 130 updates the velocity for the team using the new input for the different number of ended sprints. The prediction module 130 calculates an updated story point prediction for the future sprints by the team using the updated velocity and the expected resource capacity from the planned tasks data for the future sprints. The prediction module 130 generates and outputs an updated visualization of the updated story point prediction for the future sprints to the display 114. The prediction module 130 may perform the updating of the velocity, the calculating of the updated story point prediction, and the generating and outputting the updated visualization in real-time or near-real time in response to the new input for the number of ended sprints to include in the velocity. In this manner, a Scrum master may select the number of ended sprints to include in the velocity calculation via the GUI to see how the updated story point prediction changes with the number of included ended sprints.

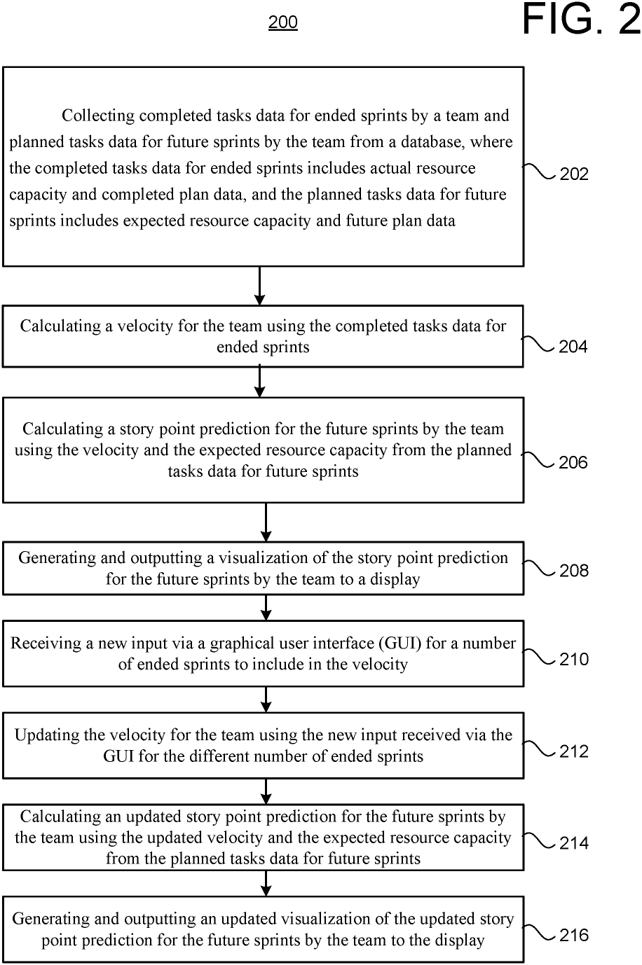

FIG. 2 is an example flowchart for a process 200 illustrating example operations of the system 100 of FIG. 1. More specifically, process 200 illustrates an example computer-implemented method for predicting story points for a team for future sprints. In some implementations, process 200 may be performed by the computing device 102. More specifically, process 200 may be performed by the application 108 and the prediction module 130. Instructions for the performance of process 200 may be stored in the at least one memory 104, and the stored instructions may be executed by the at least one processor 106. Process 200 is also illustrative of a computer program product that may be implemented as part of the application 108 and the prediction module 130.

Process 200 includes collecting completed tasks data for ended sprints by a team and planned tasks data for future sprints by the team from a database, where the completed tasks data for ended sprints includes actual resource capacity and completed plan data, and the planned tasks data for future sprints includes expected resource capacity and future plan data (202). For example, the prediction module 130 of FIG. 1 may be configured to collect completed tasks data for ended sprints by a team and planned tasks data for future sprints by the team from the database 166. In this manner, the prediction module 130 is capturing historical data for completed tasks to make story point predictions for planned tasks in future sprints.

Process 200 includes calculating a velocity for the team using the completed tasks data for ended sprints (204). For example, the prediction module 130 of FIG. 1 may calculate a velocity for each sprint completed by the team. The prediction module 130 totals or sums the story points completed by the team during the sprint. The completed plan data includes the story points completed by the team during the sprint. The prediction module 130 totals or sums the workdays for the team during the sprint. The actual resource capacity includes the number of workdays performed by the team during the sprint. The prediction module 130 calculates the velocity by dividing the summed story points by the summed workdays to arrive at the velocity for the team. As discussed above, the prediction module 130 may calculate the velocity for a number of ended sprints, and not just calculate the velocity for a single sprint.

Process 200 includes calculating a story point prediction for the future sprints by the team using the velocity and the expected resource capacity from the planned tasks data for future sprints (206). For example, the prediction module 130 of FIG. 1 uses the velocity for the team to calculate a story point prediction for the future sprints by the team. The prediction module 130 calculates the story point prediction using the velocity and the expected resource capacity form the planned tasks data for future sprints. The prediction module 130 multiplies the velocity, which is in story points per workday, by the expected resource capacity, which is in workdays, to arrive at the story point prediction, which is in story points.

Process 200 includes generating and outputting a visualization of the story point prediction for the future sprints by the team to a display (208). For example, the prediction module 130 of FIG. 1 may generate and output a visualization of the story point prediction for the future sprints by the team to the display 114. As discussed below in more detail with respect to FIGS. 3-5, the prediction module 130 generates and outputs the visualization of the story point prediction to provide a graphical representation of the story point prediction for viewing by a user. The visualization may illustrate the story point prediction for multiple future sprints, where the story point prediction may vary for each sprint based on the expected resource capacity for each of the future sprints.

Process 200 may include receiving a new input via a graphical user interface (GUI) for a number of ended sprints to include in the velocity (210). Process 200 may include updating the velocity for the team using the new input received via the GUI for the different number of ended sprints (212). Process 200 may include calculating an updated story point prediction for the future sprints by the team using the updated velocity and the expected resource capacity from the planned tasks data for future sprints (214). Process 200 includes generating and outputting an updated visualization of the updated story point prediction for the future sprints by the team to the display (216).

For example, the prediction module 130 of FIG. 1 may update the calculated story point predictions in real-time or near-real time as new input is received from the GUI for the number of ended sprints to include in the velocity. For example, in response to receiving a new input via the GUI for a different number of ended sprints to include in the velocity, the prediction module 130 updates the velocity for the team using the new input for the different number of ended sprints. The prediction module 130 calculates an updated story point prediction for the future sprints by the team using the updated velocity and the expected resource capacity from the planned tasks data for the future sprints. The prediction module 130 generates and outputs an updated visualization of the updated story point prediction for the future sprints to the display 114. The prediction module 130 may perform the updating of the velocity, the calculating of the updated story point prediction, and the generating and outputting the updated visualization in real-time or near-real time in response to the new input for the number of ended sprints to include in the velocity.

In the process 200, each time a new input is received via the GUI for the number of ended sprints to include in the velocity (210), the prediction module 130 may perform steps 212, 214, and 216 in real-time or near real-time.

FIG. 3 is an example screenshot 300 of a dashboard for displaying a visualization of the story point prediction for future sprints. The screenshot 300 may be implemented, generated, and output by the application 108 on the computing device 102. More specifically, at least portions of the dashboard may be generated and output by the prediction module 130. At least some of the information for populating the dashboard and/or the information underlying some of the information displayed on the dashboard may be collected from the database 166 and/or the database 116. Information from the database 166 may be loaded from the computing device 150 to the computing device 102 via the data load server 160.

The dashboard is configured to illustrate an area 310 that graphically displays an input mechanism to select a number of ended sprints and a graph 314 of ended sprints and future sprints.

The dashboard illustrates a velocity for a team calculated from the last three sprints performed by the team. The slide bar 302 is a user-selectable graphical implement to select the number of sprints to include in the velocity calculation performed by the prediction module 130. In this example, the slide bar 302 indicates to input information from the last three sprints for the velocity calculation. The completed tasks data is illustrated by the completed plan data (labelled as “Actual Plan”), as measured in story points. In this example, the completed plan data illustrates 71 story points completed in the first sprint, 88.6 story points completed in the second sprint, and 88.5 story points completed in the third sprint. The actual resource capacity used in these three sprints is measured in workdays and is labelled as “Capacity”. In this example, the actual resource capacity illustrates 53 workdays in the first sprint, 66 workdays in the second sprint, and 74 workdays in the third sprint.

The prediction module 130 uses the completed plan data and the actual resource capacity from these three sprints to calculate a velocity for each sprint for the team and a velocity for the three sprints for the team. As illustrated, the velocity for the first sprint is 1.3 story points per workday, the velocity of the second sprint is 1.3 story points per workday, and the velocity of the third sprint is 1.2 story points per workday. The velocity for the three sprints is 1.27 story points per workday. As discussed above, the velocity for the three sprints is calculated by the prediction module 130 by summing the story points for the three sprints (245 story points), summing the workdays for the three sprints (193 workdays), and dividing the total story points by the total workdays, which is 1.27.

The prediction module 130 then uses the velocity of 1.27 to calculate the story point prediction for the future sprints. For example, in the fourth sprint the expected resource capacity of 74 is multiplied by the velocity of 1.27 to arrive at the story point prediction of 93.9 story points. Currently, there are 89 story points planned for the fourth sprint as part of the future plan data. The graphical representation provided by the dashboard provides a visual comparison between the future plan data of 89 story points versus the predicted 93.9 story points for the fourth sprint. The Scrum master may use this information to adjust the future plan data. For example, the Scrum master may determine the team is capable of completing one or more additional task worth up to a few more story points during the fourth sprint.

The dashboard includes an area 320 that may be configured to summarize the sprint information for each completed sprint as well as for future sprints in a table format.

As sprints are completed, the data for the ended sprint may be captured as to the actual number of story points completed by the team during the ended sprint. Likewise, the resource capacity may be captured as to the actual workdays for the team during the sprint. This completed task information may be stored in the database 166 and used in calculating the velocity of the team.

The dashboard may be configured to pull data for various teams and/or various sprint cycles. The dashboard may include an area 330 to display team capacity (or member capacity) for each team member and for the entire team assigned to a particular sprint as part of resource capacity.

The dashboard may be configured to include an area 340 that provides a summary of metrics for the current sprint, for example, the third sprint, which is the current sprint. The metrics illustrated in the area 340 may include a ratio comparison of the actual plan in story points to the story point predicted (prediction) in story points and converted to a percentage. In this example, the percentage comparison is 94.7%. The other metrics illustrated in the area 340 include the actual plan in story points (89), the expected resource capacity in workdays (74), the story point prediction in story points (94), and the velocity for the team over the last three sprints (1.27 story points per workday).

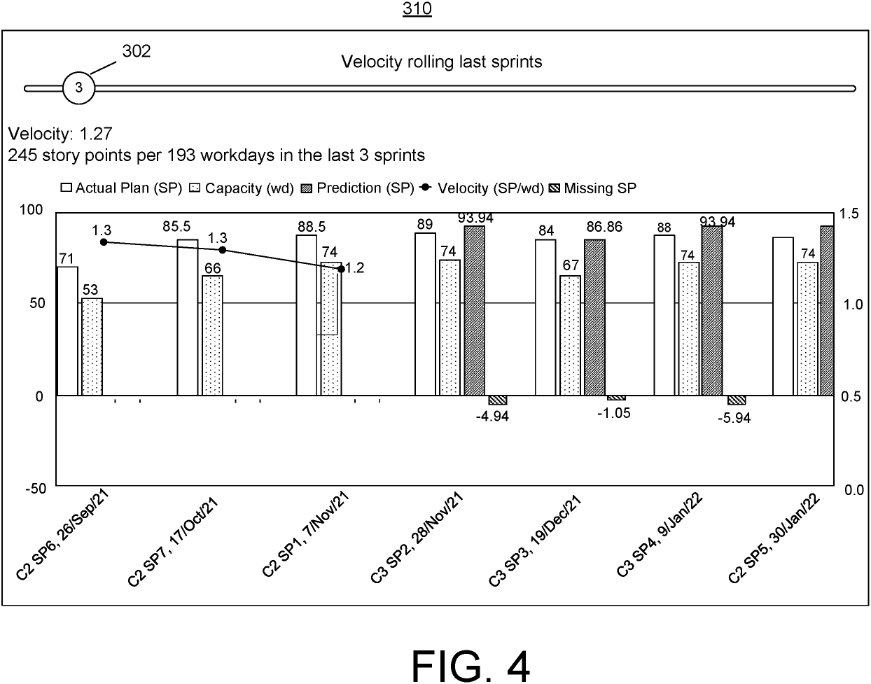

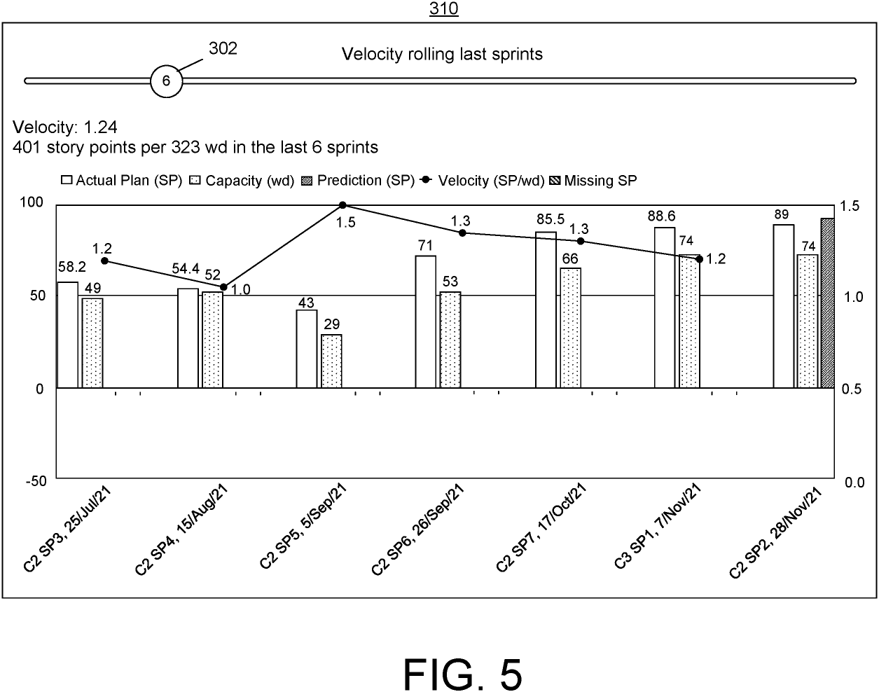

FIG. 4 is an example screenshot of the area 310 of the dashboard from FIG. 3. As noted above, the area 310 illustrates the slide bar 302 as an input mechanism to select the number of ended sprints to include in the velocity. In this example, the slide bar 302 is selected at three ended sprints. FIG. 5 is an example screenshot of the area 310 of the dashboard with the slide bar 302 selected to include six ended sprints in the velocity. In this manner, the prediction module 130 updates the velocity to include the last six sprints for the team instead of the last three sprints. The prediction modules 130 updates the velocity by summing the story points from the last six sprints, summing the workdays from the last six sprints, and dividing the story points by the workdays to arrive at a velocity of 1.24 story points per workday for the team. By including the last six sprints in the velocity, the velocity changed from 1.27 story points per workday to 1.24 story points per workday for the team. The updated velocity of 1.24 is then used to calculate the story point prediction for the team for future sprints and to update the visualization on the dashboard.

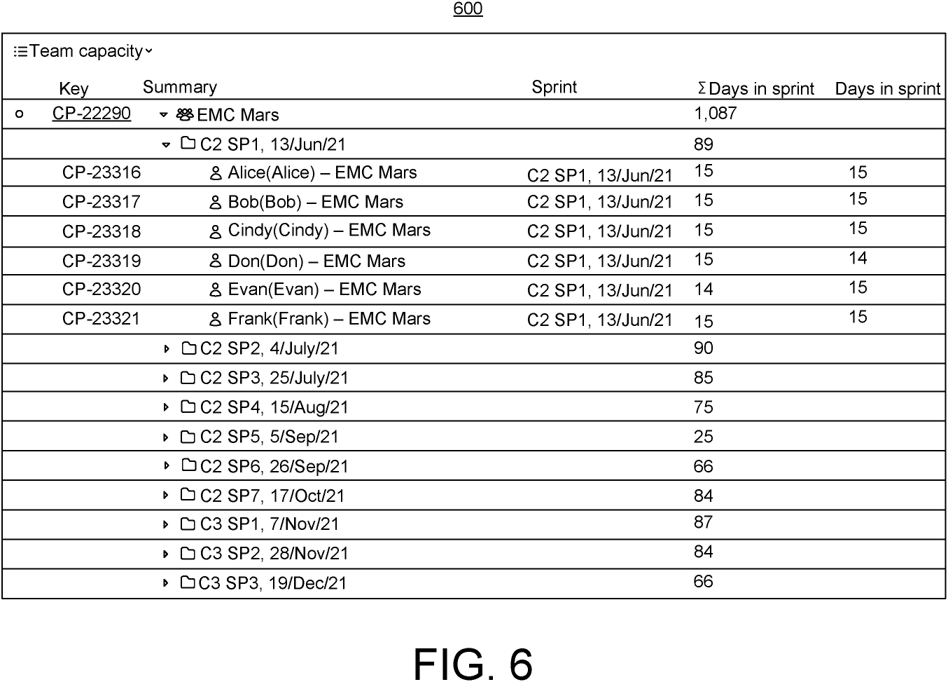

FIG. 6 is an example screen shot 600 illustrating a data entry screen for inputting the team member resource capacity. The Scrum master may fill in the “Days in sprint” field and the sprint capacity workdays (Days in sprint) for every team member.

Below are example code snippets that may be part of the instructions stored in the at least one memory 104 that are executed by the at least one processor 106. The code snippets may be part of the application 108 and the prediction module 130. The code snippets include some text explanations set off by the developer//.

The first part of the code snippets define the ended sprints and their order. The data is selected from the ended sprints and then used to calculate the velocity.

// Set Path as variable
Set vTestProd = 1;
If vTestProd = 0 Then
Set vQVDPath = ‘[lib://QVD Amos Test 2’;
else
Set vQVDPath = ‘[lib://QVD Production’;
End if
// Set the Last Sprint that we take for calculate the velocity default value. The user can
change this value in the UI.
Set vSprint = 3;
// Load Sprint Details from database 166.
SprintDetails:
LOAD
SUMMARY as [Sprint Name],
[Sprint Start Date],
[Sprint End Date]
FROM [lib://QVD Production/JiraFinalTable.qvd]
(qvd) Where [Issue Type] = ‘Sprint’;
Store * from SprintDetails into $(vQVDPath)\Sprint Details.qvd];
Drop Table SprintDetails;
// Define the Last Sprints Order
SprintOrderTmp:
LOAD Distinct
[Sprint Name],
[Sprint End Date]
FROM $(vQVDPath)\Sprint Details.qvd]
(qvd) Where [Sprint End Date] < Today();
SprintOrder:
Load Distinct
[Sprint Name],
RowNo() as OrderSprint
Resident SprintOrderTmp Order by [Sprint End Date] desc;
Load Distinct
[Sprint Name] as [Capacity Sprint Name],
OrderSprint as CapacityOrderSprint
Resident SprintOrder;
Store * From SprintOrder into $(vQVDPath)\Sprint Order Last.qvd];
Drop Table SprintOrderTmp;
TmpAggrSprintOrder:
Load distinct
OrderSprint as OrderSprint1
Resident SprintOrder;
Join
Load distinct
OrderSprint as OrderSprint2
Resident SprintOrder;
AggrSprintOrder:
Load
OrderSprint1 as [Last n Sprints],
OrderSprint2 as OrderSprint
Resident TmpAggrSprintOrder Where OrderSprint1>=OrderSprint2;
Drop Table TmpAggrSprintOrder;
Load
[Last n Sprints] as [Capacity Last n Sprints],
OrderSprint as CapacityOrderSprint
Resident AggrSprintOrder;

The next part of the code snippet loads the Scrum team sprint capacity workdays (Days in sprint) from the database 166 and sums the total capacity for the Scrum team per sprint.

ScrumTeamCapacity:
Load
[Sprint Name],
[Team Group],
[Sprint Name] as [Capacity Sprint Name],
[Team Group“&‘-’&”Sprint Name] as [Capacity Key],
Sum([Days in Sprint]) as [Scrum Team Sprint Capacity(wd)]
FROM $(vQVDPath)\Jira Fields Last.qvd]
(qvd) Where [Project Key] = ‘CP’ Group By [Team Group], [Sprint Name];
Left Join
LOAD Distinct
[Sprint Name] as [Capacity Sprint Name],
[Sprint End Date] as [Capacity Sprint End Date]
FROM $(vQVDPath)\Sprint Details.qvd]
(qvd);
Drop Fields [Scrum Team Name], [Sprint Name] From ScrumTeamCapacity;
Store * From ScrumTeamCapacity into $(vQVDPath)\Scrum Team Capacity Last.qvd];
//Load Story Points and Scrum Teams
Story Level:
LOAD Distinct
Key as [Story Level Key],
[Story Point] as [Story Level Story Point],
[Scrum Team Name] as [Story Level Scrum Team Name]
FROM $(vQVDPath)\WBL Last.qvd]
(qvd);

The next part of the code snippet is related to the generation and output of the visualization such as that illustrated in the screenshot 300 of FIG. 3. This is also referred to as the user interface (UI) code portion.

o Sprint (X Dimension)
//The last ended Sprints that the user select (In the Slider) or next Sprints (Future
Sprints).
//The number in the slide bar is the vSprint value.
= If([Sprint Name] <> ‘Backlog’ and
([Last n Sprints] = $(vSprints) or
[Sprint End Date] >= Today()), [Sprint Name])

o Actual Plan (SP) - Blue Bar
// If there is no SP fill 0, else sum the Sprint Story Points
If(Sum([Story Level Story Point]) <= 0 or IsNull(Sum([Story Level Story Point])), 0,
Sum([Story Level Story Point]))

o Capacity(wd) - Orange Bar
// Summarize the Scrum team capacity in workdays
Sum([Scrum Team Sprint Capacity(wd)])

o Prediction(SP) - Gray Bar
// Calculate the Story Point prediction
// Calculate the prediction only for future sprints
If([Sprint End Date] >= Today(),
// Calculate the velocity
// Sum the story points in the last (selected in the slider) closed sprint by Scrum Team
// Divide it by the Scrum team capacity (workdays) in the last (selected in the slider)
// and multiple it by the next sprint capacity(workdays)
(Sum(Total <[Scrum Team Name]> {<[Sprint Name] =, [Sprint End Date] =, [Last n
Sprints] = {‘$(vSprints)’}>} [Story Level Story Point])
/
Sum(Total <[Scrum Team Name]> { <[Sprint Name] =, [Sprint End Date] =, [Last n
Sprints] = {‘$(vSprints)’}>} [Scrum Team Sprint Capacity(wd)])
)
*
Sum ({<[Sprint Name] =, [Sprint End Date] =, [Last n Sprints] =>} [Scrum Team Sprint
Capacity(wd)]))

o Velocity(SP/wd) - Black Line
// Calculate the team velocity for the last sprints selected in the slider
If([Sprint End Date] < Today(),
If(Sum [Story Level Story Point]) <= 0 or IsNull(Sum([Story Level Story Point])), 0,
Sum([Story Level Story Point]))
/
Sum([Scrum Team Sprint Capacity(wd)]))

o Missing SP - Light blue Bar
Actual Plan(SP) minus Prediction (SP)

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

What is claimed is:

1. A computer-implemented method comprising:
collecting, by a computing device, from a database completed tasks data for ended sprints of a team and planned tasks data for future sprints by the team, wherein:
the completed tasks data for ended sprints includes actual resource capacity and completed plan data, and
the planned tasks data for future sprints includes expected resource capacity and future plan data;
calculating, by the computing device, a velocity for the team using the completed tasks data for ended sprints;
calculating, by the computing device, a story point prediction for the future sprints by the team using the velocity and the expected resource capacity from the planned tasks data for future sprints; and
generating and outputting to a display, by the computing device, a visualization of the story point prediction for the future sprints by the team.

2. The computer-implemented method as in claim 1, further comprising:
receiving an input via a graphical user interface (GUI) for a number of ended sprints to include in the velocity, and
wherein calculating the velocity includes calculating, by the computing device, the velocity for the team using the input received via the GUI for the number of ended sprints.

3. The computer-implemented method as in claim 2, further comprising:
receiving a new input via the GUI for a different number of ended sprints to include in the velocity;
updating, by the computing device, the velocity for the team using the new input received via the GUI for the different number of ended sprints;
calculating, by the computing device, an updated story point prediction for the future sprints by the team using the updated velocity and the expected resource capacity from the planned tasks data for future sprints; and
generating and outputting to the display, by the computing device, an updated visualization of the updated story point prediction for the future sprints by the team.

4. The computer-implemented method as in claim 1, wherein calculating the velocity includes:
summing story points from the completed plan data;
summing workdays for the team from the actual resource capacity; and
dividing the summed story points by the summed workdays to arrive at the velocity for the team.

5. The computer-implemented method as in claim 1, wherein calculating the story point prediction includes multiplying the expected resource capacity by the velocity.

6. The computer-implemented method as in claim 1, wherein generating and outputting the visualization includes generating and outputting to the display, by the computing device, the visualization of the story point prediction and the future plan data for the future sprints by the team.

7. The computer-implemented method as in claim 1, wherein:
the actual resource capacity and the expected resource capacity is measured in workdays; and
the completed plan data and the future planned data is measured in story points.

8. A computer program product, the computer program product being tangibly embodied on a non-transitory computer-readable medium and including executable code that, when executed, causes a computing device to:
collect completed tasks data for ended sprints by a team and planned tasks data for future sprints by the team from a database, wherein:
the completed tasks data for ended sprints includes actual resource capacity and completed plan data, and
the planned tasks data for future sprints includes expected resource capacity and future plan data;
calculate a velocity for the team using the completed tasks data for ended sprints;
calculate a story point prediction for the future sprints by the team using the velocity and the expected resource capacity from the planned tasks data for future sprints; and
generate and output to a display a visualization of the story point prediction for the future sprints by the team.

9. The computer program product of claim 8, further comprising executable code that, when executed, causes the computing device to:
receive an input via a graphical user interface (GUI) for a number of ended sprints to include in the velocity, and
wherein the executable code that, when executed, causes the computing device to calculate the velocity for the team using the input received via the GUI for the number of ended sprints.

10. The computer program product of claim 9, further comprising executable code that, when executed, causes the computing device to:
receive a new input via the GUI for a different number of ended sprints to include in the velocity;
update the velocity for the team using the new input received via the GUI for the different number of ended sprints;
calculate an updated story point prediction for the future sprints by the team using the updated velocity and the expected resource capacity from the planned tasks data for future sprints; and
generate and output to the display an updated visualization of the updated story point prediction for the future sprints by the team.

11. The computer program product of claim 8, wherein the executable code that, when executed, causes the computing device to calculate the velocity includes executable code that, when executed, causes the computing device to:
sum story points from the completed plan data;
sum workdays for the team from the actual resource capacity; and
divide the summed story points by the summed workdays to arrive at the velocity for the team.

12. The computer program product of claim 8, wherein the executable code that, when executed, causes the computing device to calculate the story point prediction by multiplying the expected resource capacity by the velocity.

13. The computer program product of claim 8, wherein the executable code that, when executed, causes the computing device to generate and output to the display the visualization of the story point prediction and the future plan data for the future sprints by the team.

14. The computer program product of claim 8, wherein:
the actual resource capacity and the expected resource capacity is measured in workdays; and
the completed plan data and the future planned data is measured in story points.

15. A system comprising:
at least one processor; and
a non-transitory computer-readable medium comprising instructions that, when executed by the at least one processor, cause the system to:
collect from a database completed tasks data for ended sprints by a team and planned tasks data for future sprints by the team, wherein:
the completed tasks data for ended sprints includes actual resource capacity and completed plan data, and
the planned tasks data for future sprints includes expected resource capacity and future plan data;
calculate a velocity for the team using the completed tasks data for ended sprints;
calculate a story point prediction for the future sprints by the team using the velocity and the expected resource capacity from the planned tasks data for future sprints; and
generate and output to a display a visualization of the story point prediction for the future sprints by the team.

16. The system of claim 15, further comprising instructions that, when executed by the at least one processor, cause the system to:
receive an input via a graphical user interface (GUI) for a number of ended sprints to include in the velocity, and
wherein the instructions that, when executed by the at least one processor, cause the system to calculate the velocity for the team using the input received via the GUI for the number of ended sprints.

17. The system of claim 16, further comprising instructions that, when executed by the at least one processor, cause the system to:
receive a new input via the GUI for a different number of ended sprints to include in the velocity;
update the velocity for the team using the new input received via the GUI for the different number of ended sprints;
calculate an updated story point prediction for the future sprints by the team using the updated velocity and the expected resource capacity from the planned tasks data for future sprints; and
generate and output to the display an updated visualization of the updated story point prediction for the future sprints by the team.

18. The system of claim 15, wherein the instructions that, when executed by the at least one processor calculate the velocity by causing the system to:
sum story points from the completed plan data;
sum workdays for the team from the actual resource capacity; and
divide the summed story points by the summed workdays to arrive at the velocity for the team.

19. The system of claim 15, wherein the instructions that, when executed by the at least one processor calculate the story point prediction by causing the system to multiply the expected resource capacity by the velocity.

20. The system of claim 15, wherein the instructions that, when executed by the at least one processor generate and output to the display the visualization of the story point prediction and the future plan data for the future sprints by the team.

21. The system of claim 15, wherein:
the actual resource capacity and the expected resource capacity is measured in workdays; and
the completed plan data and the future planned data is measured in story points.
